(19) United States
(12) Patent Application Publication
(10) Pub. No.: US 2007/0209259 A1
(43) Pub. Date: Sep. 13, 2007

(54) GONDOLA HEAD SUSPENSION AND SHELF SUPPORT ADAPTER

(75) Inventors: Walter Pavlik, Bad Arolson (DE); Ingolf Schulten, Manheim (DE)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: CHECKPOINT SYSTEMS, INC., Thorofare, NJ (US)

(21) Appl. No.: 11/676,606

(22) Filed: Feb. 20, 2007

Related U.S. Application Data
(60) Provisional application No. 60/776,414, filed on Feb. 24, 2006.

(51) Int. Cl. G09F 15/00

(52) U.S. Cl. 40/607.09

(57) ABSTRACT

A gondola head suspension and shelf support system that permits advertisement and other information to be suspended therefrom for display. The gondola head suspension includes an angled fitting that couples to a horizontal cantilever for suspending the advertisement and information as well as a vertical tube that engages a shelf support. The shelf support includes an adapter that is insertable within the shelf support using pliant tongues. Another variation of the gondola head suspension includes a “T-fitting” for providing two horizontal cantilevers and which also uses a vertical tube for engaging the shelf support.

### CROSS-REFERENCE TO RELATED APPLICATIONS

This utility application claims the benefit under 35 U.S.C. §119(e) of Provisional Application Ser. No. 60/776,414 filed on Feb. 24, 2006 entitled GONDOLA HEAD SUSPENSION AND SHELF SUPPORT ADAPTER and whose entire disclosure is incorporated by reference herein.

### BACKGROUND OF THE INVENTION

1. Field of Invention

This invention relates to store item presentations and more particularly to support devices for displaying items, pricing and advertisement information.

2. Description of Related Art

The use of connecting members that can be assembled to form frameworks is shown by way of example in U.S. Pat. Nos. 2,926,941 (Thompson), 3,218,097 (Bowers, et al.), 4,105,348 (Anderson, et al.), 4,128,353 (Lauterbach), 4,782,637 (Eriksson, et al.) and European Patent Nos. EP 1050244 (Odorico, et al.) and EP 0141823 (Johansson); or pipe joint structures as shown in U.S. Pat. No. 3,881,830 (Kato, et al.).

All references cited herein are incorporated herein by reference in their entireties.

### BRIEF SUMMARY OF THE INVENTION

An erectable advertisement structure which comprises: a shelf support for receiving a removable adapter therein, wherein the adapter comprises an elongated member projecting in a first direction and a plurality of tongue members projecting in a second direction, opposite the first direction, and wherein the plurality of tongue members are releasably secured inside the shelf support; and a fitting having a pair of arms that are oriented perpendicular to each other, a first arm which is releasably connected to the elongated member using a first tube and a second arm which is releasably connected to a second tube to form a first cantilever, and wherein advertisements are suspended from the cantilever.

A method for providing an erectable advertisement structure, wherein the method comprises the steps of: providing a shelf support for receiving a removable adapter therein and wherein the removable adapter comprises an elongated member projecting in a first direction and a plurality of tongue members projecting in a second direction, opposite the first direction, and wherein the plurality of tongue members are releasably secured inside the shelf support; providing a fitting having a pair of arms that are oriented perpendicular to each other; releasably connecting a first tube to the elongated member and to one of the arms; and releasably connecting a second tube to the other one of the pair of arms to form a first cantilever, and wherein advertisements are suspended from the cantilever.

### BRIEF DESCRIPTION OF SEVERAL VIEWS OF THE DRAWINGS

The invention will be described in conjunction with the following drawings in which like reference numerals designate like elements and wherein:

FIG. 1 is a side view of an angle-type gondola head suspension device, coupled to a shelf support, and including a sign suspended therefrom, and also shows a “T-type” gondola head suspension device (shown in phantom), coupled to a shelf support, with corresponding signs hanging therefrom;

FIG. 2 is an isometric view of the angle-type gondola head suspension coupled to a shelf support;

FIG. 3 is an isometric view of a “T-type” gondola head suspension device coupled to a shelf support;

FIG. 4 is an exploded view of the angle-type gondola head suspension device;

FIG. 5 is an exploded view of the angle member showing a corner fitting of the angle-type gondola head suspension device;

FIG. 6 is a cross-sectional view of the angle-type gondola head suspension device taken along line 6-6 of FIG. 4;

FIG. 7 depicts an exploded view of the T-type gondola head suspension device;

FIG. 8 is an exploded view of the T-type member showing the shells of the T-type gondola head suspension device;

FIG. 9 is an exploded isometric view of the adapter portion of the shelf support of the present invention;

FIG. 10 is an exploded view of the angle-type gondola head suspension device and a shelf support shown partially and depicting how the angle-type gondola head suspension device can be rotated 90 degrees; and

FIG. 11 is a cross-sectional view of a portion of the adapter portion of the shelf support taken along line 11-11 of FIG. 10.

### DETAILED DESCRIPTION OF THE INVENTION

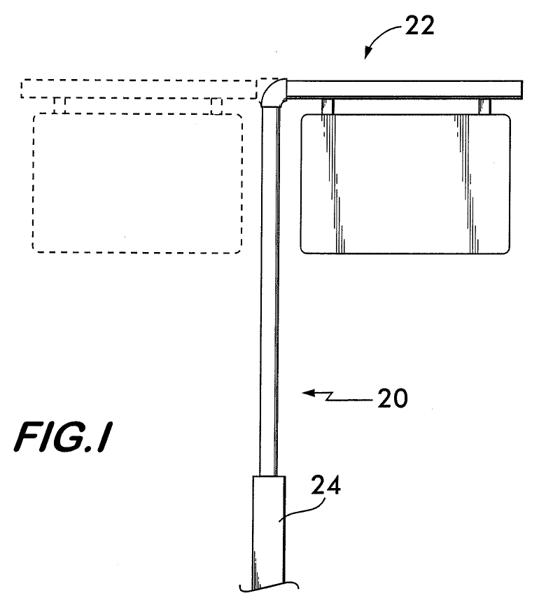

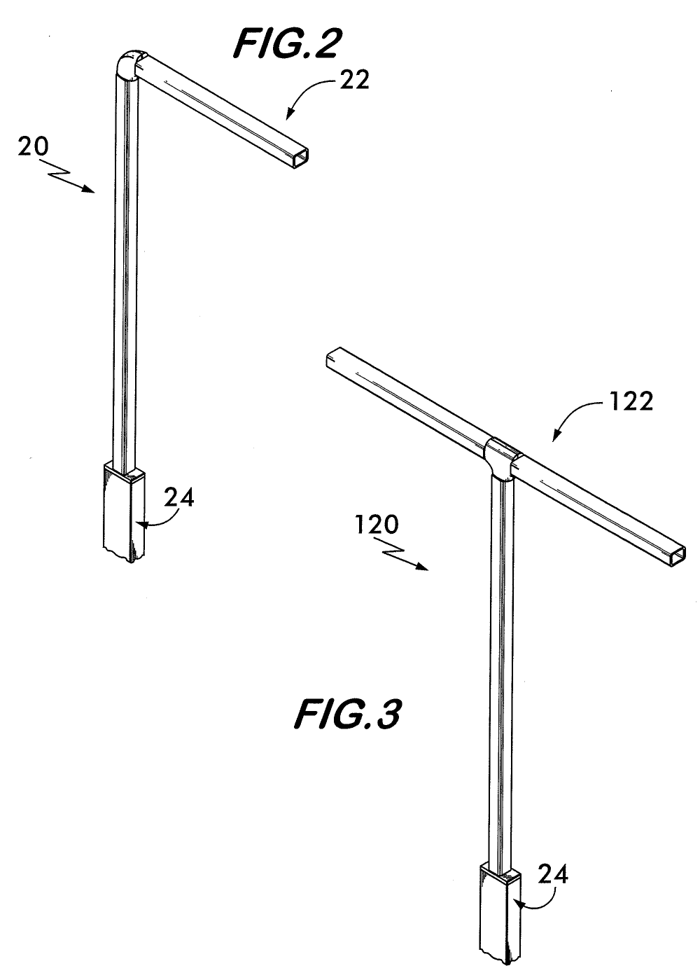

The gondola head suspension can be mounted directly to the ends of shelf supports of various manufacturers and serves to suspend larger information boards (not shown). There is an angle-type gondola head suspension system 20 (FIGS. 1-2) and a T-type gondola suspension system 120 (FIGS. 1 and 3). Each type of gondola head suspension system 20/120 comprises a respective gondola head type (angle-type gondola head suspension 22 or T-type gondola head suspension 122) and a shelf support 24.

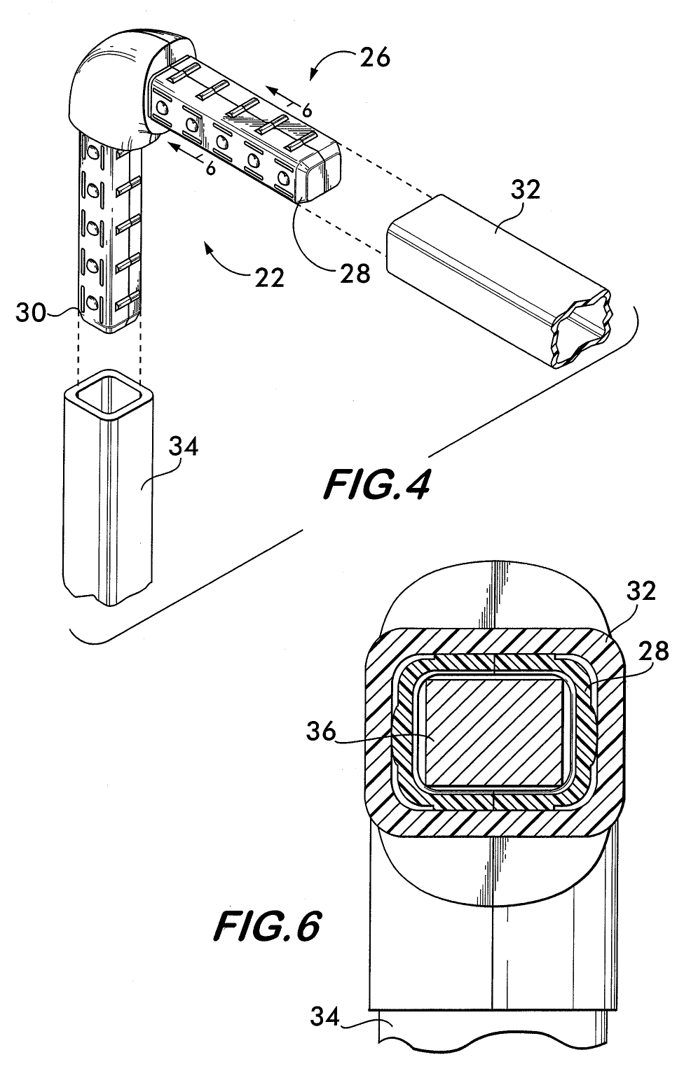

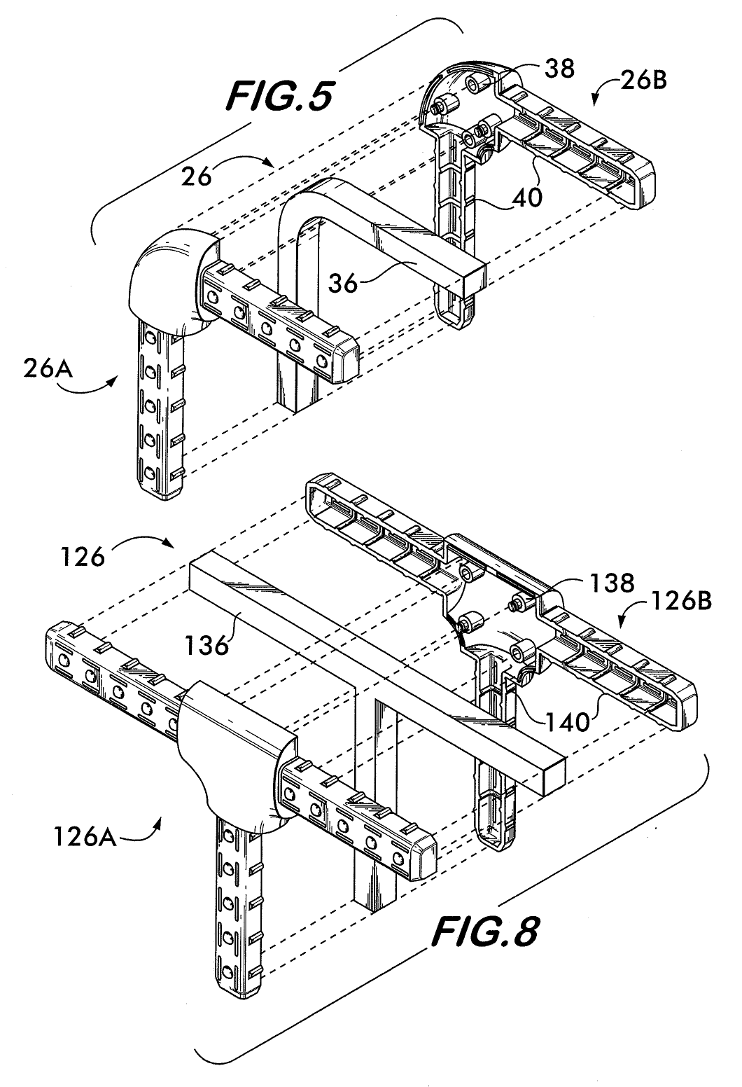

As shown in FIG. 4, the angle angle-type gondola head suspension 22 comprises a corner fitting 26 having arms 28 and 30 for receiving a respective horizontal cantilever 32 and a vertical tube 34. FIG. 5 depicts an exploded view of the corner fitting 26. The corner fitting 26 comprises two shells 26A and 26B and a metal reinforcement member 36. The two shells 26A and 26B are identical, snapping closed through inner lying cams 38 for assembly. The form and spring elements 40 (FIG. 5) of the shells 26A/26B enable a shape adjustment between the suspension tubes (cantilever 32 and vertical tube 34), e.g., rounded rectangle, (as shown most clearly in FIG. 4) and the metal reinforcement member 36 (e.g., rectangular, as shown most clearly in FIGS. 5 and 6) in addition to compensating for tolerances.

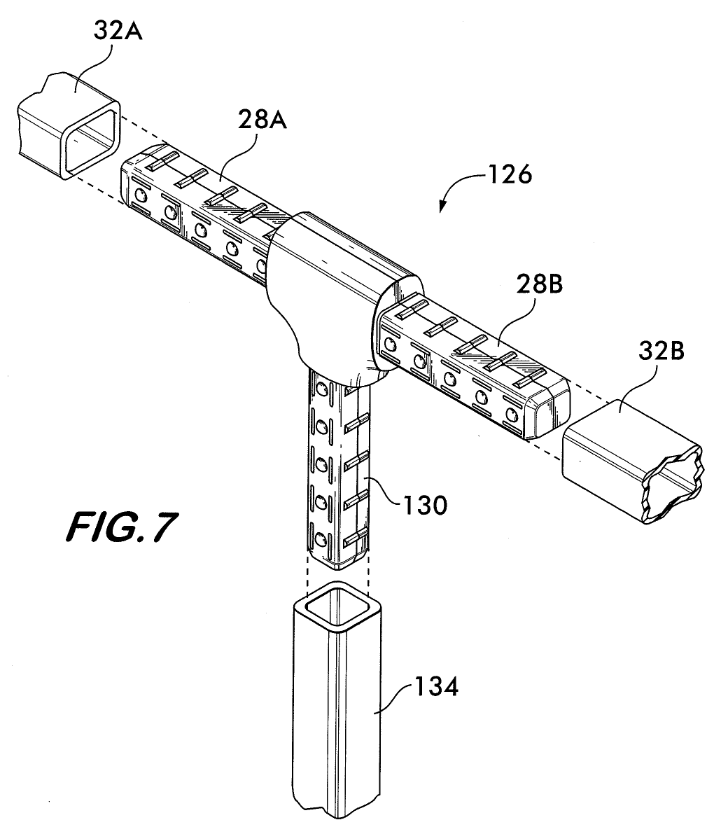

As shown in FIGS. 7-8, the T-type gondola head suspension 122 comprises a T-fitting 126 having horizontal arms 28A and 28B and a vertical arm 130 for receiving respective horizontal cantilevers 32A and 32B and a vertical tube 134. FIG. 8 depicts an exploded view of the T-fitting. The T-fitting 126 comprises two shells 126A and 126B and a metal reinforcement member 136. The two shells 126A and 126B are identical, snapping closed through inner lying cams 138 for assembly. The form and spring elements 140 (FIG. 8) of the shells 126A/126B enable a shape adjustment between the suspension tubes (cantilevers 32A/32B and vertical tube 134), e.g., rounded rectangle, (as shown most clearly in FIG. 7) and the metal reinforcement member 136 (e.g., rectangular, as shown most clearly in FIG. 8) in addition to compensating for tolerances.

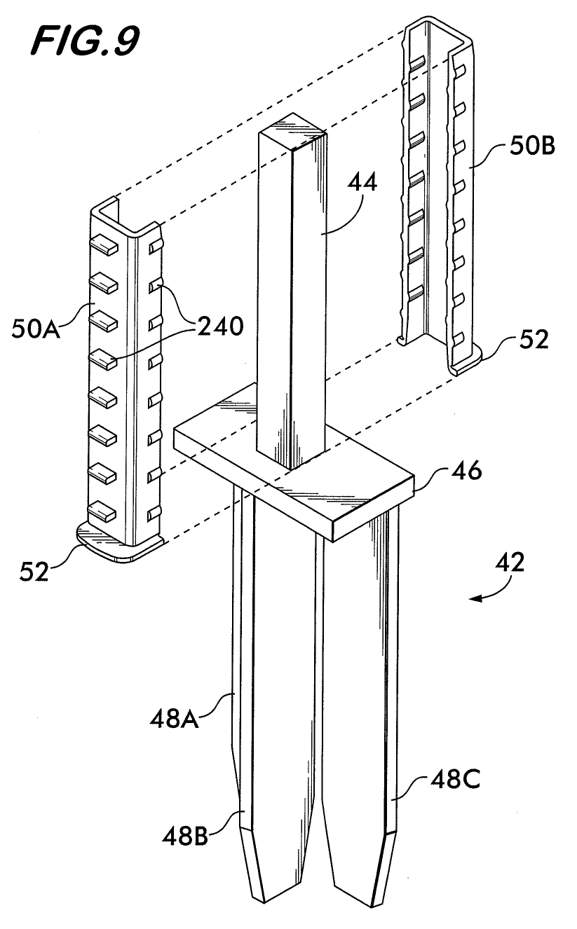

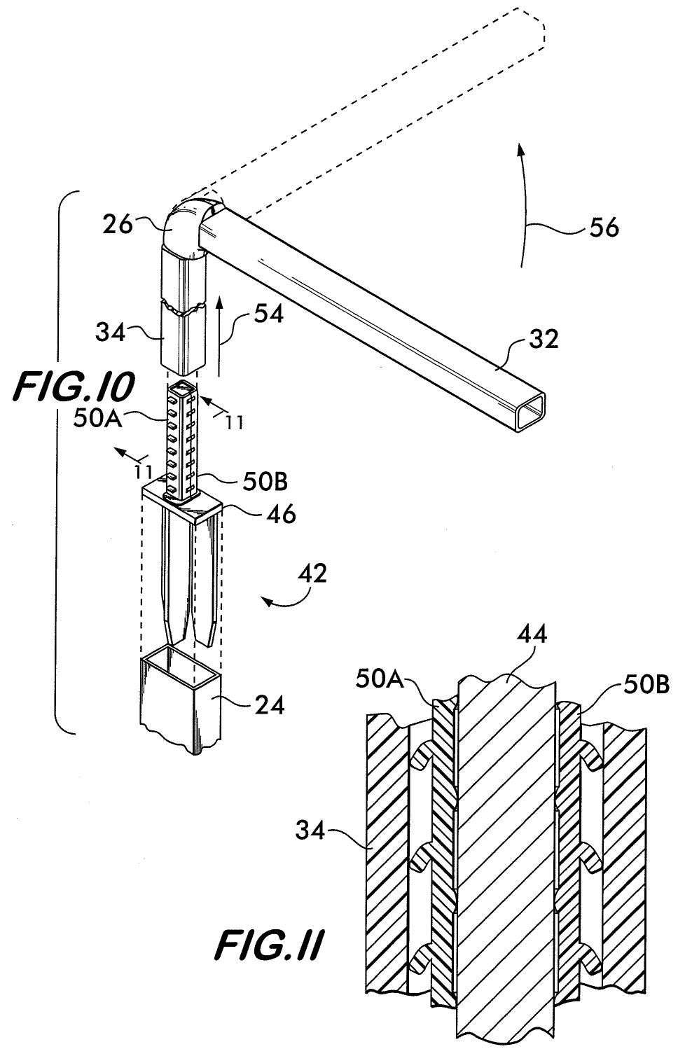

For mounting the gondola head suspensions 22 and 122, shelf supports 24 are provided. In the present invention, the gondola head suspensions 22 and 122 are coupled to the shelf supports 24 via the use of a removable adapter 42 that is insertable into the shelf support 24. This can be seen most clearly in FIG. 10. Different adapters of different sizes are required, depending on the shelf-manufacturer. To meet the individual requirements and limit the manufacturing cost, the adapter 42 is of modular and systematic design. As shown in FIG. 9, all the adapters 42 have an upper square 44 for seating engagement with the suspension 22 or 122. A base plate 46 serves as a stop during assembly into the shelf support 24 (see FIG. 10). Lower tongues 48A-48C are flexible, conforming themselves to the dimensions and tolerances of the shelf supports 24, thereby providing a releasable securement within the shelf support. All of the components are made of steel sections to DIN (Deutsches Institut für Normung e.V. which is the German Institute for Standardization) standard and are welded together.

To be able to fit the vertical, oval-cross section tube 34 or 134 of the suspension 22 or 122 onto the adaptor 42, two identical shells 50A and 50B made of plastic material are inserted between the tube 34 or 134 and the adapter square 44. The shells 50A/50B have a lower stop 52 (FIG. 9) as well as form and spring elements 240. The integrated form and spring elements 240 of the shells provide for shape adjustment between the vertical tube 34 or 134 (which are rounded rectangle in cross-section) and the adapter square 44 and compensate, due to their spring action, for the tolerances of the two elements.

Following the insertion of the adapter 42 within the shelf support 24 and engagement of the vertical suspension tube 34 or 134 with the adapter square 44, the horizontal cantilever 32 (FIG. 11) of the suspension 22 is fixed in place, thereby being aligned correctly, at right angles. Alternatively, upon using an upward pulling motion (see arrow 54 in FIG. 10) of the vertical suspension tube 34, the position of the horizontal cantilever 32 can be altered and fixed in 90-degree increments, as shown by the arrow 56.

Thus once assembled, information boards or signs (containing product information such as price, description, etc., see FIG. 1) can be removably suspended from the horizontal cantilevers 32, 32A and 32B and also secured to the vertical tubes 34 or 134. Furthermore, the angle-type gondola head suspension system 20 and the T-type gondola suspension system 120 can be erected or disassembled when necessary, since all of their components described previously can be detached from one another.

While the invention has been described in detail and with reference to specific examples thereof, it will be apparent to one skilled in the art that various changes and modifications can be made therein without departing from the spirit and scope thereof.

What is claimed is:

1. An erectable advertisement structure, said structure comprising:
a shelf support for receiving a removable adapter therein, said adapter comprising an elongated member projecting in a first direction and a plurality of tongue members projecting in a second direction, opposite said first direction, said plurality of tongue members being releasably secured inside said shelf support; and
a fitting having a pair of arms that are oriented perpendicular to each other, a first arm being releasably connected to said elongated member using a first tube and a second arm being releasably connected to a second tube to form a first cantilever, and wherein advertisements are suspended from said cantilever.

2. The erectable advertisement structure of claim 1 wherein said fitting comprises a third arm that is oriented directly opposite said second arm, said structure further comprising a third tube that is releasably connected to said third arm to form a second cantilever opposite said first cantilever.

3. The erectable advertisement structure of claim 1 wherein said fitting comprises an L-shaped reinforcement member trapped between two L-shaped shells that are secured together, said L-shaped shells forming an oval-shaped cross-section when secured together.

4. The erectable advertisement structure of claim 2 wherein said fitting comprises a T-shaped reinforcement member trapped between two T-shaped shells that are secured together, said T-shaped shells forming an oval-shaped cross-section when secured together.

5. The erectable advertisement structure of claim 1 wherein said elongated member comprises an adapter square that is trapped between two elongated shells that are secured together, said elongated shells forming an oval-shaped cross-section when secured together.

6. The erectable advertisement structure of claim 1 wherein said adapter further comprises a base plate to which said elongated member and said plurality of tongues are attached, said base plate providing a stop when said adapter is releasably secured inside said shelf support.

7. The erectable advertisement structure of claim 4 wherein said elongated member comprises an adapter square that is trapped between two elongated shells that are secured together, said elongated shells forming an oval-shaped cross-section when secured together.

8. The erectable advertisement structure of claim 4 wherein said adapter further comprises a base plate to which said elongated member and said plurality of tongues are attached, said base plate providing a stop when said adapter is engaged with said shelf support.

9. A method for providing an erectable advertisement structure, said method comprising the steps of:
providing a shelf support for receiving a removable adapter therein and wherein said removable adapter comprises an elongated member projecting in a first direction and a plurality of tongue members projecting in a second direction, opposite said first direction, said plurality of tongue members being releasably secured inside said shelf support;
providing a fitting having a pair of arms that are oriented perpendicular to each other;
releasably connecting a first tube to said elongated member and to one of said arms; and
releasably connecting a second tube to said other one of said pair of arms to form a first cantilever, and wherein advertisements are suspended from said cantilever.

10. The method of claim 9 wherein said step of providing a fitting comprises providing a third arm that is oriented directly opposite said other one of said pair of arms.

11. The method of claim 10 further comprising the step of releasably connecting a third tube that is releasably connected to said third arm to form a second cantilever opposite said first cantilever.

12. The method of claim 10 wherein said step of providing a fitting comprises forming said fitting by trapping an L-shaped reinforcement member between two L-shaped shells that are secured together, said L-shaped shells forming an oval-shaped cross-section when secured together.

13. The method of claim 10 wherein said step of providing a fitting comprises forming said fitting by trapping a T-shaped reinforcement member between two T-shaped shells that are secured together, said T-shaped shells forming an oval-shaped cross-section when secured together.

14. The method of claim 9 wherein said step of providing a shelf support comprises forming said elongated member of said adapter by trapping an adapter square between two elongated shells that are secured together, said elongated shells forming an oval-shaped cross-section when secured together.

15. The method of claim 9 wherein said step of providing a shelf support comprises providing said adapter with a base plate to which said elongated member and said plurality of tongues are attached, said base plate providing a stop when said adapter is releasably secured inside said shelf support.

16. The method of claim 11 wherein said step of providing a shelf support comprises forming said elongated member of said adapter by trapping an adapter square between two elongated shells that are secured together, said elongated shells forming an oval-shaped cross-section when secured together.

17. The method of claim 11 wherein said step of providing a shelf support comprises providing said adapter with a base plate to which said elongated member and said plurality of tongues are attached, said base plate providing a stop when said adapter is releasably secured inside said shelf support.

18. The method of claim 9 further comprising the steps of
disengaging said first tube from said elongated member;
rotating said first tube 90 degrees about an axis of said elongated member; and
re-connecting said first tube to said elongated member.
